(19) United States
(12) Patent Application Publication
(10) Pub. No.: US 2017/0026128 A1
(43) Pub. Date: Jan. 26, 2017

(54) Highly Efficient Method For Inverse Multiplexing In An Ethernet Access Network

(71) Applicant: Futurewei Technologies, Inc., Plano, TX (US)

(72) Inventors: Duane Remein, Raleigh, NC (US); Frank Effenberger, Colts Neck, NJ (US); Yuanqiu Luo, Cranbury, NJ (US)

(21) Appl. No.: 15/215,088

(22) Filed: Jul. 20, 2016

Related U.S. Application Data
(60) Provisional application No. 62/195,556, filed on Jul. 22, 2015.

(51) Int. Cl. H04B 10/27; H04L 12/861; H04L 12/741; H04L 29/06

(52) U.S. Cl. CPC H04B 10/27; H04L 69/22; H04L 49/9005; H04L 45/745

(57) ABSTRACT

An Ethernet access network system for inverse multiplexing can comprise a reconciliation sublayer (RS) transmitter and an RS receiver. The RS transmitter can be configured to retrieve an LLID from a data stream; determine bonded channel connections at an ONU corresponding to the LLID, wherein each bonded channel connection is coupled to a FIFO buffer of a plurality of FIFO buffers; route one or more packets of the data stream to a first FIFO buffer of the plurality of FIFO buffers in response to the first FIFO buffer having a lowest fill rate; and transmit the one or more packets across the bonded channel connections. The RS receiver can be configured to receive the one or more packets; and arrange the one or more packets in order based on a packet order indicator.

### CROSS-REFERENCE TO RELATED APPLICATIONS

This application claims the benefit of U.S. Provisional Application No. 62/195,556, filed on Jul. 22, 2015, entitled “Highly Efficient Method For Inverse Multiplexing In An Ethernet Access Network,” which is hereby incorporated by reference in its entirety.

### BACKGROUND

Next generation passive optical network (PON) systems are in early development. Obtaining media access control (MAC) rates beyond about 25 gigabits per second (Gbps) may be difficult to achieve economically using a single wavelength due to optical impairments. Higher level modulation schemes, such as duo-binary and pulse-amplitude modulation (PAM)-4 will already be required for 25 Gpbs MAC rates. One solution for achieving delivery of MAC rates above the current 10 Gbps is 802.1ad Link Aggregation (LAG). However LAG has serious drawbacks. The main drawback is that LAG cannot reach the aggregate link capacity but typically only achieves between 40-60% of the aggregate rate for the individual links. In order to achieve delivery of MAC rates above the current 10 Gbps or potential future 25 Gbps, some form of inverse multiplexing (also called channel bonding) may be required.

### SUMMARY

In one embodiment, a MAC client can include a reconciliation sublayer (RS) transmitter. In various embodiments, the RS transmitter can comprise a Preamble Replacement & Idle Insertion (PRII) component configured to receive a data stream of packets; a multiplexer coupled to the PRII component and configured to selectively route the data stream of packets; a plurality of first-in first-out (FIFO) buffers coupled to the multiplexer and configured to buffer the data stream of packets; and a channel select logic component coupled to the PRII component, the multiplexer, and the plurality of FIFO buffers. The channel select logic component is configured to receive a Logical Link Identification (LLID) from the data stream, where the LLID identifies an intended endpoint destination for the data stream; retrieve one or more identifiers of buffers corresponding to the LLID from a look-up table; compare fill rates of the plurality of FIFO buffers corresponding to the one or more identifiers of buffers; select a selected buffer having a lowest fill rate of the plurality of FIFO buffers; and route the data stream to the selected buffer in response to a channel select signal provided to the multiplexer by the channel select logic component.

In some examples or embodiments, each of the one or more FIFO buffers is connected to an individual channel for communicating with one or more optical network units (ONUs). In some examples or embodiments, the intended endpoint destination is a first ONU for receiving the data stream of packets, wherein the first ONU is configured to communicate using one or more channels, and wherein each channel of the one or more channels operates at a different wavelength and data rate. In some examples or embodiments, the one or more channels operate at 100 megabits per second, 1 Gbps, 10 Gbps, and 25 Gbps, respectively. In some examples or embodiments, the look-up table stores the one or more identifiers of buffers for communicating with the one or more ONUs, and wherein the look-up table is indexed by the LLID. In some examples or embodiments, the RS transmitter is part of a MAC client of an optical line terminal (OLT). In some examples or embodiments, the look-up table is populated during an initialization phase of the OLT. In some examples or embodiments, the PRII component inserts a packet sequence number (PSN) into a header of each packet in the data stream, and wherein the PSN enumerates a sequence of packets within a frame. In some examples or embodiments, the intended endpoint destination arranges the data stream of packets based on the PSN. In some examples or embodiments, the intended endpoint destination arranges the data stream of packets based on an arrival time of a first byte of each packet of the data stream.

In another embodiment, a method for inverse multiplexing in an Ethernet access network can comprise receiving, at a PRII component of an RS transmitter, a data stream of packets; receiving, at a channel select logic component of the RS transmitter, LLID from the data stream, where the LLID identifies an intended endpoint destination for the data stream; retrieving, by the channel select logic component, one or more identifiers of FIFO buffers corresponding to the LLID from a look-up table; comparing, by the channel select logic component, fill rates of one or more FIFO buffers corresponding to the one or more identifiers of FIFO buffers; selecting, by the channel select logic component, a selected buffer having a lowest fill rate of the one or more FIFO buffers; and routing, by a multiplexer, the data stream to the selected buffer in response to a channel select signal provided by the channel select logic component.

In some examples or embodiments, each of the one or more FIFO buffers is connected to an individual channel for communicating with one or more ONUs. In some examples or embodiments, the intended endpoint destination is a first ONU for receiving the packets, wherein the first ONU is configured to communicate using one or more channels, and wherein each channel of the one or more channels operates at a different wavelength and data rate. In some examples or embodiments, the look-up table stores the one or more identifiers of FIFO buffers for communicating with the one or more ONUs, and wherein the look-up table is indexed by the LLID. In some examples or embodiments, the RS transmitter is part of an optical line terminal (OLT) or an ONU.

In a third embodiment, an Ethernet access network system for inverse multiplexing can comprise an RS transmitter and an RS receiver. The RS transmitter can be configured to retrieve an LLID from a data stream; determine bonded channel connections at an ONU corresponding to the LLID, wherein each bonded channel connection is coupled to a FIFO buffer of a plurality of FIFO buffers; route one or more packets of the data stream to a first FIFO buffer of the plurality of FIFO buffers in response to the first FIFO buffer having a lowest fill rate; and transmit the one or more packets across the bonded channel connections. The RS receiver can be configured to receive the one or more packets; and arrange the one or more packets in order based on a packet order indicator.

In some examples or embodiments, the packet order indicator is an arrival time of a first byte of each packet of the one or more packets. In some examples or embodiments, the packet order indicator is a PSN, and wherein the RS transmitter inserts a PSN field into a header of each packet of the one or more packets.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a PON;

FIG. 2 is a schematic diagram of a network element;

FIG. 3A illustrates an EPON layer representation architecture;

FIG. 3B illustrates an exemplary EPON representation architecture;

FIG. 4 illustrates an exemplary EPON transmitter architecture;

FIG. 5 is a flowchart of an exemplary method of inverse multiplexing in an Ethernet access network;

FIG. 6 illustrates an exemplary EPON receiver architecture;

FIG. 7 illustrates an exemplary packet transmission timing diagram; and

FIG. 8 is a table illustrating a header with a packet sequence number field.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

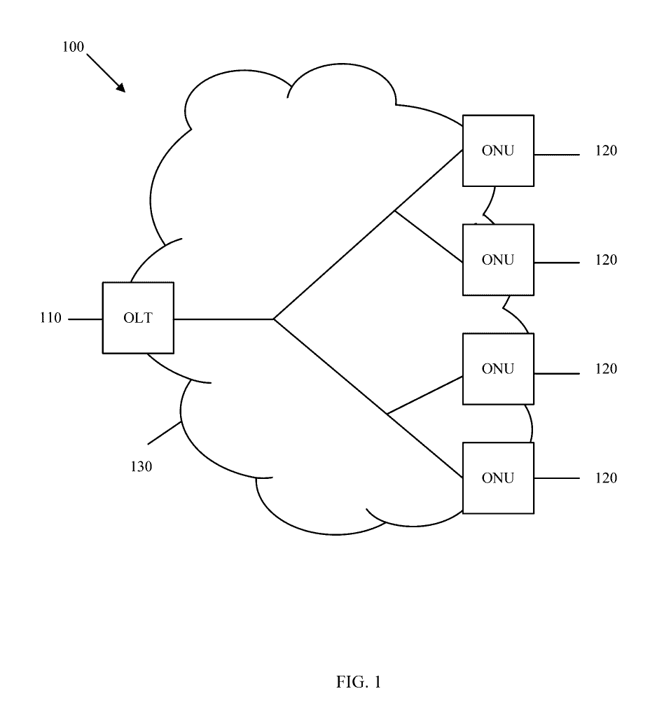

FIG. 1 is a schematic diagram of a PON 100. The PON 100 comprises an OLT 110, a plurality of ONUs 120, and an optical distribution network (ODN) 130 that couples the OLT 110 to the ONUs 120. The PON 100 is suitable for implementing the disclosed embodiments. The PON 100 is a communications network that may not require active components to distribute data between the OLT 110 and the ONUs 120. Instead, the PON 100 may use passive optical components in the ODN 130 to distribute data between the OLT 110 and the ONUs 120. The PON 100 may comprise a next-generation PON (NG-PON), a gigabit-capable PON (G-PON), a 10 gigabit per second PON (XG-PON), an EPON, a 10 gigabit per second EPON (10G-EPON), a next-generation EPON (NG-EPON), a wavelength-division multiplexing (WDM) PON, a time- and wavelength-division multiplexing (TWDM) PON, or another suitable PON.

The OLT 110 communicates with the ONUs 120 and another network or networks (not shown). Specifically, the OLT 110 is an intermediary between the other network and the ONUs 120. For instance, the OLT 110 forwards data received from the other network to the ONUs 120 and forwards data received from the ONUs 120 to the other network. The OLT 110 comprises a transmitter and a receiver. When the other network uses a network protocol that is different from the protocol used in the PON 100, the OLT 110 comprises a converter that converts the network protocol to the PON protocol and vice versa. The OLT 110 is typically located at a central location such as a CO, but it may also be located at other suitable locations.

The ODN 130 is a data distribution system that comprises optical fiber cables, couplers, splitters, distributors, and other suitable components. The components include passive optical components that do not require power to distribute signals between the OLT 110 and the ONUs 120. The components may also include active components such as optical amplifiers that do require power. The ODN 130 extends from the OLT 110 to the ONUs 120 in a branching configuration as shown, but the ODN 130 may be configured in any other suitable point-to-multipoint (P2MP) configuration.

The ONUs 120 communicate with the OLT 110 and a customer (not shown) and act as an intermediary between the OLT 110 and the customer. For instance, the ONUs 120 forward data from the OLT 110 to the customer and forward data from the customer to the OLT 110. The ONUs 120 comprise an optical transmitter that transmits optical signals to the OLT 110 and an optical receiver that receives optical signals from the OLT 110. The ONUs 120 further comprise a converter that converts optical signals into electrical signals and converts electrical signals into optical signals. The ONUs 120 further comprise a second transmitter that transmits the electrical signals to the customer and a second receiver that receives electrical signals from the customer. ONUs 120 and optical network terminals (ONTs) are similar, and the terms may be used interchangeably. The ONUs 120 are typically located at distributed locations such as customer premises, but they may also be located at other suitable locations.

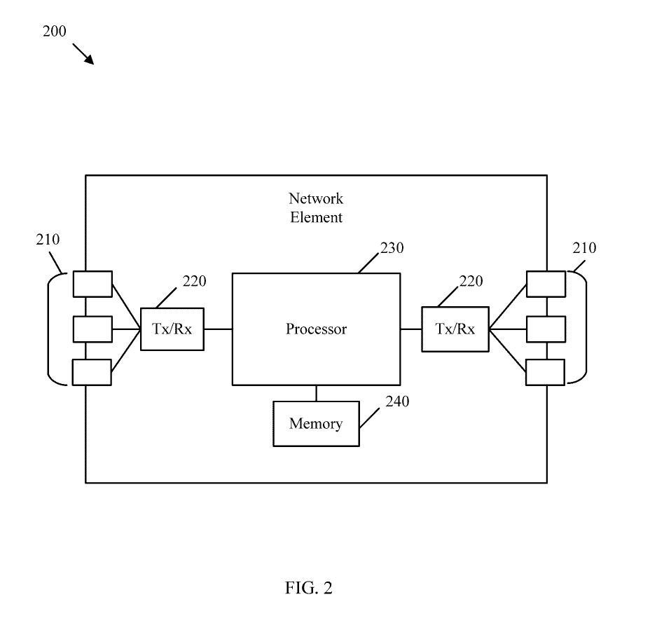

FIG. 2 is a schematic diagram of a network element 200 for channel bonding in a multiple-channel PON system. The network element 200 may be suitable for implementing the disclosed embodiments. For instance, the network element 200 may be implemented as an OLT or an ONU. Network element 200 comprises ports 210, transceiver units (Tx/Rx) 220, a processor 230, and a memory 240. Ports 210 are coupled to Tx/Rx 220, which may be transmitters, receivers, or combinations thereof. The Tx/Rx 220 may transmit and receive data via the ports 210. Processor 230 is configured to process data. Memory 240 is configured to store data and instructions for implementing embodiments described herein. The network element 200 may also comprise electrical-to-optical (EO) components and optical-to-electrical (OE) components coupled to the ports 210 and Tx/Rx 220 for receiving and transmitting electrical signals and optical signals.

The processor 230 may be implemented by hardware and software. The processor 230 may be implemented as one or more central processing unit (CPU) chips, logic units, cores (e.g., as a multi-core processor), field-programmable gate arrays (FPGAs), application specific integrated circuits (ASICs), or digital signal processors (DSPs). The processor 230 is in communication with the ports 210, Tx/Rx 220, and memory 240.

The memory 240 comprises one or more of disks and solid-state drives and may be used as an over-flow data storage device, to store programs when such programs are selected for execution, and to store instructions and data that are read during program execution. The memory 240 may be volatile and non-volatile and may be read-only memory (ROM), random-access memory (RAM), ternary content-addressable memory (TCAM), and static random-access memory (SRAM). The processor 230 and memory 240 can be configured to implement the various transmitter and receiver embodiments disclosed herein.

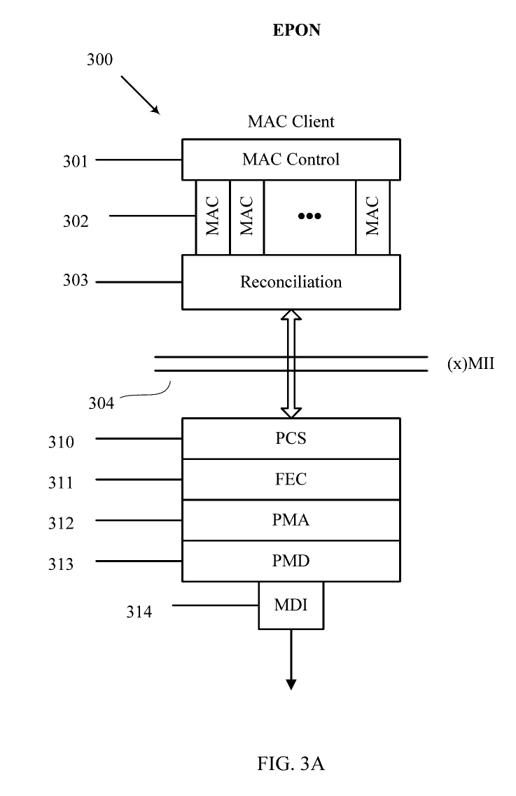

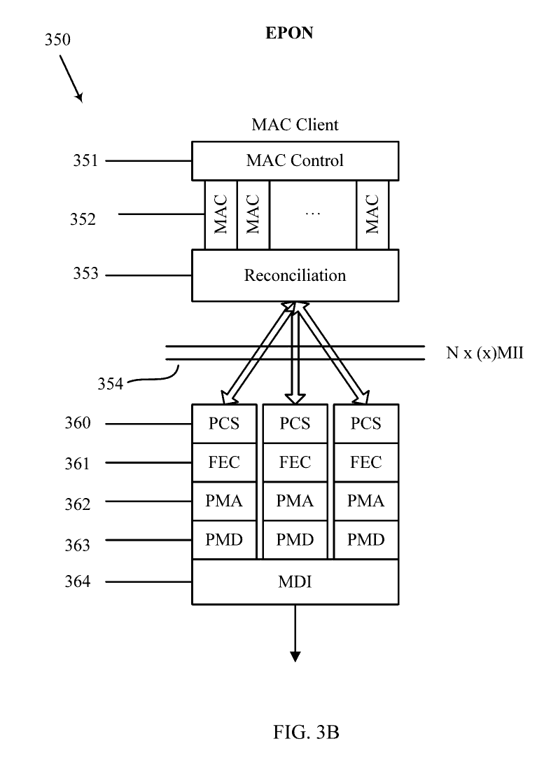

FIG. 3A illustrates an Ethernet passive optical network (EPON) layering diagram specified by IEEE 802.3ah-2004 and IEEE 802.3av-2009, wherein the layering diagram illustrates a MAC client 300 comprising a MAC control layer 301, a plurality of MAC layers 302, and a reconciliation sublayer (RS) 303. The RS 303 is associated with one media independent interface ((x)MII) 304, one physical coding sublayer (PCS) 310, one forward error control (FEC) 311, one physical medium attachment (PMA) 312, one physical medium dependent (PMD) 313, and one medium dependent interface (MDI) 314. As used herein, (x)MII 304 indicates that the media independent interface described herein is intended to cover multiple types of interfaces, including MIT (100 megabits per second (Mbps)), GMII (1 Gbps), XGMII (10 Gbps), and any additional interface operating at various rates. The MAC client 300 can be present in both an optical line terminal (OLT) and an optical network unit (ONU). Data is transmitted between the OLT and multiple ONUs in the EPON.

Disclosed herein is an Ethernet access network system for inverse multiplexing, the system having an RS transmitter and an RS receiver. The RS transmitter retrieves an LLID of a data frame to determine which possible channels can be used to transmit the frame to the destination end point. The RS transmitter has multiple FIFO buffers, each corresponding to a channel having a different wavelength and data rates. Once the possible channels are determined, the RS transmitter buffers packets of the frame into the FIFO buffer having the lowest fill rate. The frame is transmitted across the bonded channel connections to a receiver at the end point. The receiver receives the packets and arranges the packets in order based on either first byte arrival time of the packets or a packet sequence number inserted by the RS transmitter.

Control of transmission over multiple channels can be achieved using multiplexing. Channel selection is based on channel connection availability and the fill rate of the possible channel buffers. Packets are reordered as needed at the receiving end by either a MAC Control layer or a Reconciliation layer. The received packets can be reordered based on a packet sequence number (PSN), located in a header of each packet. Or the packets can be reordered based on an arrival time of a first byte of each packet.

FIG. 3B illustrates a layering diagram of a MAC client 350 in an EPON according to various embodiments. The MAC client 350 is similar to the MAC client 300, except the MAC client 350 communicates traffic at a higher rate. The MAC client 350 comprises a MAC control layer 351, a plurality of MAC layers 352, and a RS 353. The RS 353 is associated with multiple (x)MIIs 354, multiple PCSs 360, multiple FECs 361, multiple PMAs 362, multiple PMDs 363, and an MDI 364. The MAC client 350 can be present in both an OLT and an ONU. The MAC client 350 is configured to transmit data between an OLT and an ONU using channel bonding by communicating packets over multiple channels between the OLT and the ONU. The multiple (x)MIIs 354, the multiple PCSs 360, the multiple FECs 361, the multiple PMAs 362, and multiple PMDs 363 facilitate the channel bonding communications to occur within a single MAC client 350.

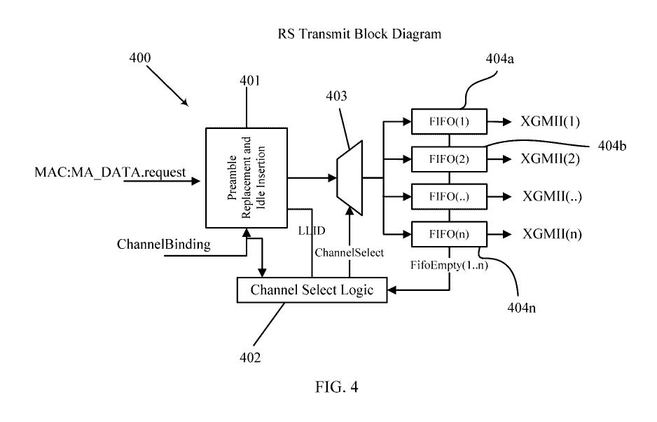

In various embodiments and with reference to FIG. 4, a RS transmitter 400 comprises a PRII component 401 in communication with a multiplexer 403, which provides data transmissions to one or more of a plurality of FIFO buffers 404ₐ-404ₙ. Each output of the multiplexer 403 is in communication with one of the buffers of the plurality of FIFO buffers 404ₐ-404ₙ. In various embodiments, each buffer of the plurality of FIFO buffers 404ₐ-404ₙ is provided to different media independent interfaces, which may have different interface data rates. The plurality of FIFO buffers 404ₐ-404ₙ can be configured to accommodate rate adaptation between MAC operating at aggregate rate and an (x)MII interface rate. The data transmission in the RS transmitter 400 is controlled by a channel select logic component 402.

A normal preamble sequence of a packet in the data transmission is 0x55, 0x55, 0x55, 0x55, 0x55, 0x55, 0x55, SFD (start of frame delimiter). In various embodiments, the PRII component 401 in an EPON RS layer changes the preamble sequence to: /S/ (Start), 0x55, SLD (start of LLID delimiter, 0x5D), 0x55, 0x55, Mode/LLID (2 bytes), CRC8 (covering SLD to LLID). In other embodiments and as described more fully below, the PRII component 401 further modifies the EPON preamble to include the packet sequence number (PSN) in byte position 4 or 5 before the Mode/LLID so the full preamble is: /S/, 0x55, SLD, 0x55, PSN, Mode/LLID, CRC8 or: /S/, 0x55, SLD, PSN, 0x55, Mode/LLID, CRC8.

The channel select logic component 402 can be configured to control data flow and distribute packets per channel bonding characteristics. The channel select logic component 402 receives an input of LLID information from the PRII component 401. The channel select logic component 402 also receives information regarding the buffer fill rate for each FIFO buffers 404a-404n, and thus the flow rate of the associated channel. The next packet of the data frame is sent on the potential channel having the lowest buffer fill rate. The channel select logic component 402 sends a channel select signal to the multiplexer 403, thereby controlling which output of the multiplexer and corresponding FIFO buffer 404 is selected. The channel select logic component 402 determines the channel select signal based on the LLID information and the buffer fill rate information. Each frame in the incoming data stream is associated with an LLID for logical identification of an ONU in the network.

In various embodiments, each data frame in the data stream is routed to a selected buffer on a packet-by-packet basis. For each packet, the channel select logic component 402 determines a current selected buffer based on the lowest fill rate of the potential buffers. In one embodiment, the channel select logic 402 receives the LLID from the PRII 401 for each frame as the frame arrives. The channel select logic 402 retrieves which data rate(s) and associated wavelengths the identified ONU is configured to terminate and the FIFO buffer(s) corresponding to the data rate(s). All the packets in the frame are routed to the corresponding FIFO buffer(s), with each packet routed to the FIFO buffer having the lowest fill rate at the time. For example, the first four packets of a frame may be routed to a first buffer associated with a first channel because the first buffer has the lowest fill rate. A fifth packet of the frame may be routed to a second buffer associated with a second channel because the second buffer has the lowest fill rate at the time the fifth packet is routed. A sixth packet of the frame may be routed to the first buffer because the first buffer once again has the lowest fill rate at the time the sixth packet is routed. From the FIFO buffers 404a-404n, the packets are transmitted to the ONU identified by the LLID using the one media independent interface associated with the FIFO buffers 404a-404n. When a new frame is received, the process is repeated with a new LLID. In various embodiments, each data frame in the data stream is routed to a selected buffer on a frame-by-frame basis.

In accordance with various embodiments, the channel select logic component 402 uses a look-up table storing LLIDs and corresponding buffer identifiers to determine the channel select signal. In various embodiments, the look-up table stores an index of LLIDs and information relating to which interface rate channels are supported for termination at a specific ONU identified by each LLID. Each ONU may be configured for one or more interface rate channel communications. For example, a first ONU may be configured to communicate using xMII(1), xMII(2), and xMII(3), but a second ONU may be configured to communicate using only xMII(1). The look-up table provides the information as to which channels are possible for successful communication to a specific ONU. In various embodiments, the look-up table can be populated during an initialization phase of the OLT. In various embodiments, the table information is a combination of provisioning and retrieved from the ONU during the ranging/discovery process. Provisioning allows/disallows use of some channels, whereas capability discovery confirms the ONUs ability to use the provisioned channels. Further, the look-up table can be stored in a memory of the channel select logic component 402. In other embodiments, the look-up table is stored in an external memory and accessed by the channel select logic 402. The external memory can be provisioned during initialization or maintenance processes.

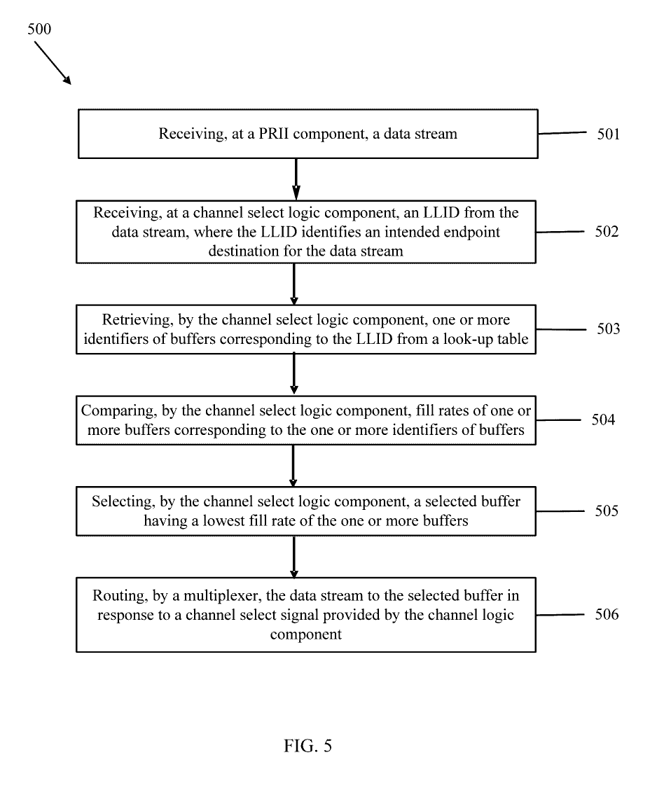

FIG. 5 is a flowchart 500 of a method of data transmission through a RS transmitter according to an embodiment. A method 500 may be implemented by the RS transmitter 400 when transmitting information to a receiver. With reference to FIG. 5, an exemplary method 500 of data transmission through an RS transmitter comprises the steps of receiving, at a PRII component, a data stream 501; and receiving, at a channel select logic component, an LLID from the data stream, where the LLID identifies an intended endpoint destination for the data stream 502. The exemplary method further comprises retrieving, by the channel select logic component, one or more identifiers of buffers corresponding to the LLID from a look-up table 503; comparing, by the channel select logic component, fill rates of one or more buffers corresponding to the one or more identifiers of buffers 504; selecting, by the channel select logic component, a selected buffer having a lowest fill rate of the one or more buffers 505; and routing, by a multiplexer, the data stream to the selected buffer in response to a channel select signal provided by the channel logic component 506.

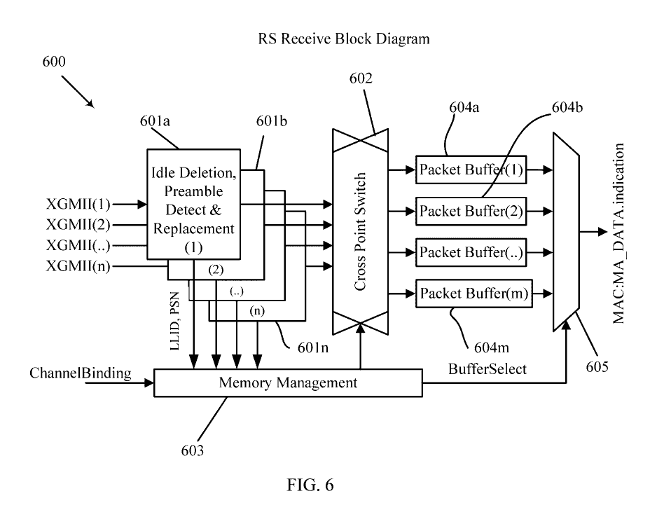

In various embodiments and with reference to FIG. 6, a RS receiver 600 comprises a plurality of Idle Deletion, Preamble Detection & Replacement (IDPRDR) components 601ₐ-601ₙ in communication with a cross point switch 602, which provides incoming data packets to a plurality of packet buffers 604ₐ-604ₘ, where m≧n. Each output of the cross point switch 602 is in communication with one of the packet buffers 604ₐ-604ₘ and a memory management component 603 controls the data flow through the RS receiver 600. The RS receiver 600 further comprises a data selector 605 in communication with the plurality of packet buffers 604ₐ-604ₘ. Each IDPRDR component 601 corresponds to an (x)MII channel. The cross point switch 602 can be configured to route packets received from the IDPRDR components 601ₐ-601ₙ to a proper packet buffer (one per MAC).

The data packets may be received out of order at the RS receiver 600. The packets are provided to the packet buffers 604ₐ-604ₘ, and packet reordering can occur through the discharging of specific buffers in a determined order. In various embodiments, the memory management component 603 receives a channel binding signal from a management entity (not shown), and receives an LLID and a packet order indicator from each of the IDPRDR components 601ₐ-601ₙ. The packet order indicator may be the packet arrival time or a packet sequence number, which will be described in further detail hereafter. The channel binding signal may be provisioned to indicate that LLID “X” corresponds to MAC “X”, and whether it is or is not a bonded channel. The memory management component 603 applies the received signals and generates a buffer select signal. The buffer select signal is provided to the data selector 605 and can be used to select an appropriate buffer, from the plurality of packet buffers 604ₐ-604ₘ, for providing buffer data in sequential order to the data selector 605. A completed and properly ordered frame is fed out of the data selector 605.

Each IDPRDR component in the IDPRDR components 601ₐ-601ₙ can be configured to remove idle data in the received packets. The IDPRDR component can be further configured to detect the packet order indicator and the LLID field from the received packets, and pass the information to the memory management component 603 to facilitate the received packet reordering. Additionally, in various embodiments, the IDPRDR component can be configured to replace a frame preamble by replacing an inserted packet order indicator in addition to the LLID currently defined in EPON. For example, the EPON preamble, such as /S/, 0x55, SLD, 0x55, PSN, Mode/LLID, CRC8, is replaced with a standard MAC preamble, such as 0x55, 0x55, 0x55, 0x55, 0x55, 0x55, 0x55, SFD.

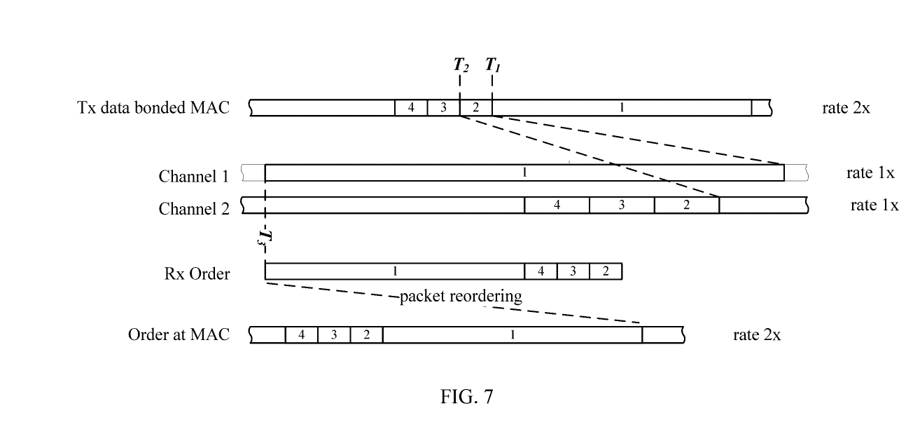

As mentioned above, the packet order indicator retrieved by the memory management 603 may be a packet arrival time or a packet sequence number associated with each packet. The packet order indicator can be used to reorder any packets that may be received out of order. By way of example, FIG. 7 illustrates a transmission of packets and the reordering at a receiver. Four packets are sent by a transmitter, such as RS transmitter 400, with packet 1 being a large packet, and packets 2, 3, and 4 being shorter packets. The four packets can be transmitted through bonded Channel 1 and Channel 2 to a receiver, such as RS receiver 600. Large packet 1 is assigned to Channel 1, and packets 2, 3, and 4 are assigned to Channel 2 of the two bonded channels. As shown, at time T₁, the large packet 1 starts arriving on Channel 1. At time T₂, short packet 2 arrives followed by packets 3 and 4. As packet 2 arrives at the receiver, it is followed by packets 3 and 4, while packet 1 is still in transit. At time T₃, packet 1 is fully received, such that the order of packet completion at the receiver is packet 2, packet 3, packet 4, and packet 1. The receiver can then reorder the packets and deliver the reordered packets in the correct order of packet 1, packet 2, packet 3, and packet 4.

The determination of packet order can be based on packet arrival time in accordance with various embodiments. As shown in FIG. 7, a first byte packet 1 arrives at the receiver first at time T₁ and a first byte of packet 2 arrives second at time T₂. The order at the MAC of the receiver can be based on the first byte packet arrival time, yielding the correct order of packet 1, packet 2, packet 3, and packet 4. In this embodiment, the packet order indicator is the packet arrival time.

In other embodiments, the packet order indicator is a PSN. When the RS transmitter 400 is configured to add a PSN to a modified EPON preamble for bonded channels at the transmitter side of communication, the PSN is inserted into a packet header by the PRII 401 in the RS transmitter 400. In such a case, the RS receiver 600 can be configured to reassemble packets in proper order based on the PSN, which is extracted by the IDPRDR components 601ₐ-601ₙ.

A preamble replacement of an EPON protocol can be enhanced to include a PSN, which allows a receiver to return packets to original order regardless of whether reordering occurs during transmission. In EPON systems, the Inter Packet GAP (IPG) and Start of Frame Delimiter (SFD) can be partially replaced with an EPON specific header. The EPON specific header can include the LLID, the start of LLID delimiter (SLD), and a cyclic redundancy check (for example, CRC8). In various embodiments, a PSN field can be added to the header, which can be used to properly reconstruct the packet order at the receiver. The new EPON specific header, including SLD, MAC specific PSN, LLID and CRC8 could be used for all frames that are from a MAC that makes use of inverse multiplexing.

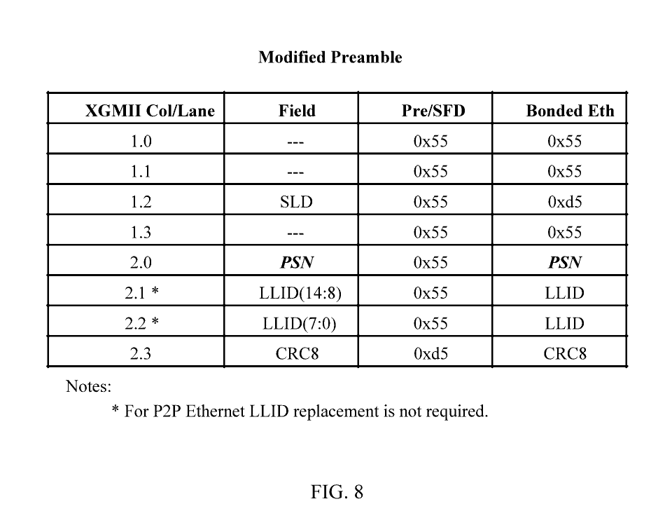

FIG. 8 illustrates one byte in the existing Ethernet preamble can be used to carry the added field of the PSN, which indicates the packet transmission sequence from the transmitter. In various embodiments, one PSN is used per MAC. The PSN is illustrated as an 8 bit value but other sizes can be used as long as Equation 1 can be met. The PSN is used to indicate the order of frames received from a MAC Client at the transmitting RS. At the receiver, the PSN is used to reorder frames from the order received over the media, to match the order sent from the MAC Client. The PSN having an 8 bit value allows for >10:1 ratio between lowest physical layer (PHY) rate and aggregate PHY rate (differential transfer time between largest packet at slowest link rate relative to smallest packets at aggregate rate is important).

In various embodiments, the PSN could occupy either column 0 lane 4 or column 1 lane 1 (or both if deemed necessary) per Table 76-3 [65-1] of IEEE Standard 802.3, 2012, IEEE Standard for Ethernet, which is hereby incorporated by reference. The PSN is essentially a binary count. The value of 0x55, currently used in this position in the EPON specific preamble, should be reserved for channels that do not support bonding. In accordance with various embodiments, the RS maintains one PSN counter for each bonded LLID or MAC Client.

The size of the PSN field can be dependent on the maximum packet size, the total aggregate data rate and the data rate of the slowest link rate in the bonded channels. The size of the PSN field can be given by the formula:

$$\frac{PS max}{R min} > PSN \times \frac{PS min}{( {\sum }_{0}^{n - 1} Ri ) - R min} \qquad ( Equation 1 )$$

wherein PSmax=maximum packet size, Rmin=minimum channel rate, PSN=number of packet sequence numbers, PSmin=minimum packet size, Ri=data rate of channel i, and n=number of channels.

In various embodiments, adding the PSN field to the EPON specific header would require a minimum number of changes to the existing EPON 10 Gbps PHY. Further, such changes may be contained in the RS layer of the EPON OLT or ONU. In addition, changes to allow use of multiple channels may also be needed in the MAC Control or MPCP layer. For some embodiments, the implementation of the disclosed embodiments may achieve a high data rate but may suffer from higher than expected latency and packet jitter for the observed data rate. However, it is possible to combine bonded channels with non-bonded channels over the same PHY without loss in total data capacity. Thus, the disclosed embodiments can provide a very high potential data capacity increase with little additional complexity.

The various advantages of the disclosed embodiments may include providing higher MAC rate over existing PHYs, and allowing for coexistence of lower rate ONUs with higher rate ONUs in an efficient manner. Additionally, the disclosed embodiments may be significantly more efficient than the currently implemented method of 802.1ad Link Aggregation. One objective of the disclosed embodiments is to enable a service provider to offer a high capacity service over an existing optical distribution network (ODN) while retaining many of the existing components of the 10G-EPON system. In particular, disclosed embodiments may enable retention of existing ONUs while providing the high capacity service, which would be very beneficial to service providers. Furthermore, in various embodiments, the EPON system with EPON specific header can support bonding across channels of differing data capacities (i.e., non-uniform channels). The embodiments may be extensible from a few to tens of channels, depending on the uniformity of the individual rate of the channels. The various embodiments may be applicable to Ethernet access markets (both EPON & P2P Ethernet), as well as applicable to GPON markets.

The disclosed embodiments provide for aggregation of link capacity at the expense of total delay. Another benefit of this solution is that it will allow existing ONUs to continue to be utilized on the same links that are being used for bonded ONU. LAG also requires the use of multiple MACs, whereas the current embodiments can be implemented over a single MAC per ONU. Further, the disclosed embodiments build on the existing EPON protocol, require little change, and can be optimized for next generation PON standards that include WDM techniques, as in next-generation PON 2 (NGPON2) or as is expected for next generation EPON (NG-EP ON).

The NGPON2 standard and the NG-EPON standard include, or may include, a multi-stream feature wherein WDM techniques are used to allow increased data capacity over a single ODN. The disclosed embodiments are advantageous in that higher MAC data rates can be achieved than can be achieved over any single time-division multiplexing (TDM) PON stream (currently 10 Gbps for NGPON2 and expected to be about 25 Gbps for NG-EPON). Further, disclosed embodiments can be configured to operate non-bonded ONUs and bonded ONUs over the same links. The result is a homogeneous access network where high performance business services and low cost residential services can be delivered using the same technologies and over the same ODN. In accordance with the various embodiments, the disclosed embodiments achieve these advantages with little increase in complexity to the existing EPON RS layer and no required changes in the PCS/PMA layers.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A reconciliation sublayer (RS) transmitter, comprising:
a Preamble Replacement & Idle Insertion (PRII) component configured to receive a data stream of packets;
a multiplexer coupled to the PRII component and configured to selectively route the data stream of packets;
a plurality of first-in first-out (FIFO) buffers coupled to the multiplexer and configured to buffer the data stream of packets; and
a channel select logic component coupled to the PRII component, the multiplexer, and the plurality of FIFO buffers, wherein the channel select logic component is configured to:
receive Logical Link Identification (LLID) from the data stream, where the LLID identifies an intended endpoint destination for the data stream;
retrieve one or more identifiers of buffers corresponding to the LLID from a look-up table;
compare fill rates of the plurality of FIFO buffers corresponding to the one or more identifiers of buffers;
select a selected buffer having a lowest fill rate of the plurality of FIFO buffers; and
route the data stream to the selected buffer in response to a channel select signal provided to the multiplexer by the channel select logic component.

2. The RS transmitter of claim 1, wherein each of the one or more FIFO buffers is connected to an individual channel for communicating with one or more optical network units (ONUs).

3. The RS transmitter of claim 2, wherein the intended endpoint destination is a first ONU for receiving the data stream of packets, wherein the first ONU is configured to communicate using one or more channels, and wherein each channel of the one or more channels operates at a different wavelength and data rate.

4. The RS transmitter of claim 3, wherein the one or more channels operate at 100 megabits per second, 1 gigabits per second (Gbps), 10 Gbps, and 25 Gbps, respectively.

5. The RS transmitter of claim 2, wherein the look-up table stores the one or more identifiers of buffers for communicating with the one or more ONUs, and wherein the look-up table is indexed by the LLID.

6. The RS transmitter of claim 5, wherein the RS transmitter is part of a media access control (MAC) client of an optical line terminal (OLT).

7. The RS transmitter of claim 6, wherein the look-up table is populated during an initialization phase of the OLT.

8. The RS transmitter of claim 1, wherein the PRII component inserts a packet sequence number (PSN) into a header of each packet in the data stream, and wherein the PSN enumerates a sequence of packets within a frame.

9. The RS transmitter of claim 8, wherein the intended endpoint destination arranges the data stream of packets based on the PSN.

10. The RS transmitter of claim 1, wherein the intended endpoint destination arranges the data stream of packets based on an arrival time of a first byte of each packet of the data stream.

11. A method for inverse multiplexing in an Ethernet access network, comprising:
receiving, at a Preamble Replacement & Idle Insertion (PRII) component of an reconciliation sublayer (RS) transmitter, a data stream of packets;
receiving, at a channel select logic component of the RS transmitter, Logical Link Identification (LLID) from the data stream, where the LLID identifies an intended endpoint destination for the data stream;
retrieving, by the channel select logic component, one or more identifiers of first-in first-out (FIFO) buffers corresponding to the LLID from a look-up table;
comparing, by the channel select logic component, fill rates of one or more FIFO buffers corresponding to the one or more identifiers of FIFO buffers;
selecting, by the channel select logic component, a selected buffer having a lowest fill rate of the one or more FIFO buffers; and
routing, by a multiplexer, the data stream to the selected buffer in response to a channel select signal provided by the channel select logic component.

12. The method of claim 11, wherein each of the one or more FIFO buffers is connected to an individual channel for communicating with one or more optical network units (ONUs).

13. The method of claim 12, wherein the intended endpoint destination is a first ONU for receiving the packets, wherein the first ONU is configured to communicate using one or more channels, and wherein each channel of the one or more channels operates at a different wavelength and data rate.

14. The method of claim 12, wherein the look-up table stores the one or more identifiers of FIFO buffers for communicating with the one or more ONUs, and wherein the look-up table is indexed by the LLID.

15. The method of claim 12, wherein the RS transmitter is part of an optical line terminal (OLT) or an ONU.

16. An Ethernet access network system for inverse multiplexing, the system comprising:
a reconciliation sublayer (RS) transmitter configured to:
retrieve a Logical Link Identification (LLID) from a data stream;
determine bonded channel connections at an optical network unit (ONU) corresponding to the LLID, wherein each bonded channel connection is coupled to a first-in first-out (FIFO) buffer of a plurality of FIFO buffers;
route one or more packets of the data stream to a first FIFO buffer of the plurality of FIFO buffers in response to the first FIFO buffer having a lowest fill rate; and
transmit the one or more packets across the bonded channel connections; and
a RS receiver configured to:
receive the one or more packets; and
arrange the one or more packets in order based on a packet order indicator.

17. The system of claim 16, wherein the packet order indicator is an arrival time of a first byte of each packet of the one or more packets.

18. The system of claim 16, wherein the packet order indicator is a packet sequence number (PSN), and wherein the RS transmitter inserts a PSN field into a header of each packet of the one or more packets.
